(19) United States
(12) Patent Application Publication
(10) Pub. No.: US 2008/0021693 A1
(43) Pub. Date: Jan. 24, 2008

(54) Storage Device Simulator

(75) Inventors: Bruce A. Campbell, Bellevue, WA (US); Stuart J. Harper, Seattle, WA (US); Peter D. Shier, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/459,124

(22) Filed: Jul. 21, 2006

(51) Int. Cl. G06F 13/10

(52) U.S. Cl. 703/21

(57) ABSTRACT

A storage device simulator is created on a computing device. The storage device simulator is connected to an operating system of the computing device, wherein the storage device simulator interacts with the operating system without modification of the operating system.

### CROSS-REFERENCE TO RELATED APPLICATION

This application is related to commonly assigned U.S. patent application Ser. No. 10/435,481, filed May 8, 2003, titled “System and Method for Testing, Simulating, and Controlling Computer Software and Hardware”, which is incorporated herein by reference in its entirety.

### BACKGROUND

Software is often tested for its interaction with hardware storage devices. For example, system software must handle the adding and removing of storage devices under routine conditions as well as unexpected ones, such as a surprise removal. In enterprise systems, complex storage area networks may contain hundreds or even thousands of nodes, and many terabytes of data, requiring complex software to use and manage them. Also, software often must deal with a wide variety of storage device formats and protocols that may advance quickly in features, performance, and capacity.

Testing the interaction of software with storage devices usually requires manual intervention by a human test engineer. The human test engineer may physically operate the storage device in order to test the interaction of the device with the software. Such manual testing is slow and test results may be subject to human error.

Software simulations may be used to imitate a storage device for testing. However, today's simulations of storage devices are of low fidelity and do not capture the actual behavior of the storage devices. Also, such simulations are not integrated with an operating system in the same way as a physical storage device.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments herein provide a simulated storage device. These simulated storage devices may be used to test software, such as device drivers. The simulated storage devices may simulate storage capacity, read/write functionality, and disk timing parameters of the storage device being simulated. In one embodiment, the storage device simulator interacts with an operating system such that the operating system is unaware that the storage device is simulated.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram of an example operating environment to implement embodiments of the invention;

FIG. 2 is a block diagram of a storage device simulator in accordance with an embodiment of the invention;

FIG. 3 is a block diagram of a storage device simulator in accordance with an embodiment of the invention; and

FIG. 4 is a flowchart illustrating the logic and operations of creating and operating a storage device simulator in accordance with an embodiment of the invention.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Embodiments of the invention include a simulated Universal Serial Bus (USB) storage device. Embodiments of the invention may comport with various USB specifications. Such specifications include, but are not limited to, the “Universal Serial Bus Specification,” Revision 2.0, Apr. 27, 2000, commonly referred to as USB 2.0 and the “Wireless Universal Serial Bus Specification,” Revision 1.0, May 12, 2005. One skilled in the art having the benefit of this description will appreciate that embodiments of the invention may also be used with other types of buses and connections. Such bus architectures include, but are not limited to, Fibre Channel, Serial Attached SCSI (Small Computer System Interface) (SAS), iSCSI (Internet SCSI), IEEE (Institute of Electrical and Electronics Engineers) 1394, Advanced Technology Attachment (ATA), Serial ATA, and the like.

In addition, while embodiments herein are described in relation to object-oriented programming, it will be understood that embodiments of the invention may be implemented using other programming environments.

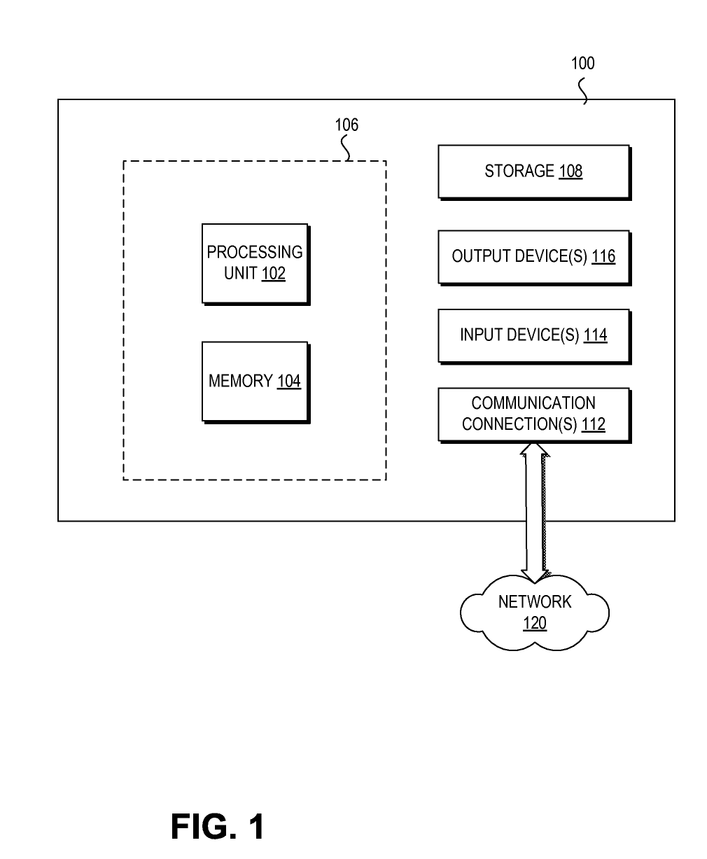

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of computer readable instructions, such as program modules, being executed by one or more computers or other devices. Computer readable instructions may be distributed via computer readable media (discussed below). Generally, program modules include routines, programs, objects, components, data structures, etc., that perform particular tasks or implement particular abstract data types. Typically, the functionality of the program modules may be combined or distributed as desired in various environments.

FIG. 1 shows an exemplary system for implementing one or more embodiments of the invention in a computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by storage 108. In one embodiment, computer readable instructions to implement embodiments of the invention may be stored in storage 108.

The term “computer readable media” as used herein includes both computer storage media and communication media. Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communication connection(s) 112 that allow computing device 100 to communicate with other devices, such as with other computing devices through network 120. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may also have input device(s) 114 such as keyboard, mouse, pen, voice input device, touch input device, laser range finder, infra-red cameras, video input devices, and/or any other input device. Output device(s) 116 such as one or more displays, speakers, printers, and/or any other output device may also be included.

Those skilled in the art will realize that storage devices utilized to store computer readable instructions may be distributed across a network. For example, a remote computer accessible via network 120 may store computer readable instructions to implement one or more embodiments of the invention. A local or terminal computer may access the remote computer and download a part or all of the computer readable instructions for execution. Alternatively, the local computer may download pieces of the computer readable instructions as needed, or distributively process by executing some instructions at the local terminal and some at the remote computer (or computer network). Those skilled in the art will also realize that by utilizing conventional techniques known to those skilled in the art, all or a portion of the computer readable instructions may be carried out by a dedicated circuit, such as a Digital Signal Processor (DSP), programmable logic array, and the like.

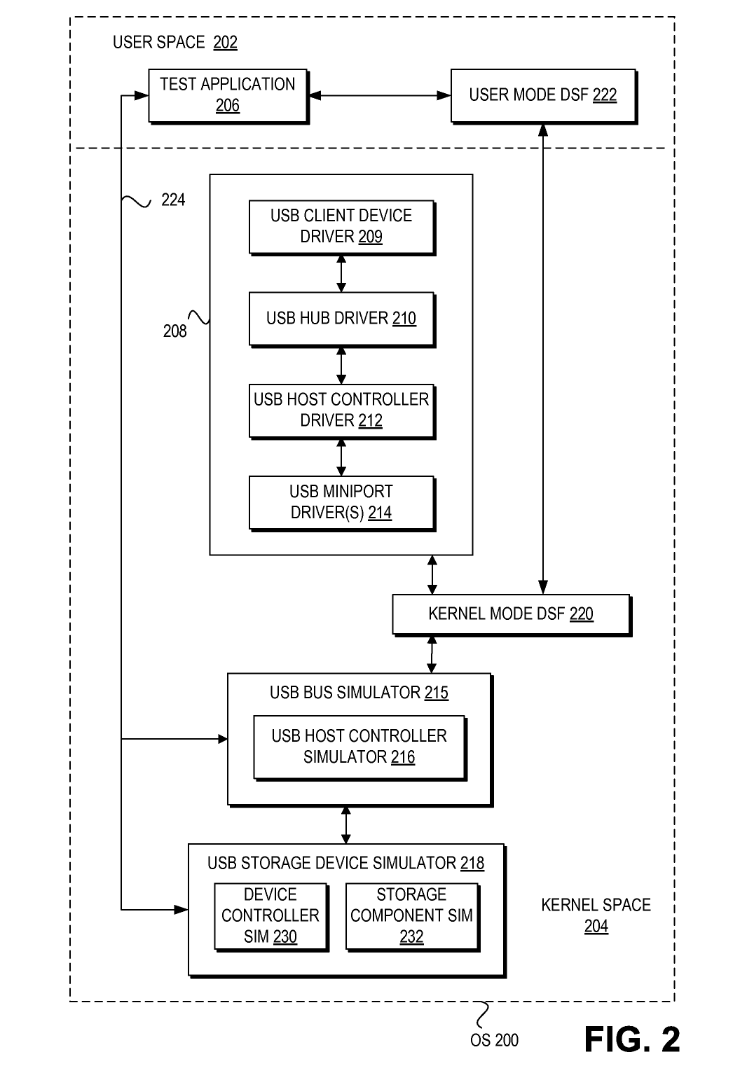

Turning to FIG. 2, a USB bus simulator 215 and a USB storage device simulator 218 in accordance with embodiments of the invention are shown. While the embodiment of FIG. 2 is implemented using USB, alternative embodiments may be implemented using other bus architectures.

USB bus simulator 215 includes a USB host controller simulator 216 that simulates a hardware USB host controller. In one embodiment, a hardware USB host controller may be part of a computing device chipset. In one embodiment, USB host controller simulator 216 comports with the “Enhanced Host Controller Interface Specification for Universal Serial Bus,” Revision 1.0, Mar. 12, 2002. In other embodiments, USB host controller simulator 216 may comport with other USB host controller designs, such as Universal Host Controller Interface (UHCI), Open Host Controller Interface (OHCI), Wireless Host Controller Interface (WHCI), and the like.

FIG. 2 shows one USB host controller simulator 216 and one USB storage device simulator 218 for the sake of clarity, but one skilled in the art will appreciate that embodiments herein may include multiple host controllers each connected to one or more storage device simulators. Further, simulated USB storage devices may be connected to a simulated external USB hub.

USB storage device simulator 218 simulates a USB hardware storage device. USB storage device simulator 218 may include a device controller simulator 230 and a storage component simulator 232 to simulate storage media and/or associated mechanisms. In one embodiment, USB storage device simulator 218 includes a mass storage device class as defined by the USB specification, revision 2.0. USB storage device simulator 218 may simulate storage devices, such as, but not limited to, a magnetic disk drive, such as a hard disk drive, an optical disk drive, such as a DVD, a flash drive, a magnetic media card, and the like. USB storage device simulator 218 may simulate storage devices that are part of electronic devices such as cameras, media players, and the like, that may be connected to a computer system via a USB connection. In an embodiment simulating a disk drive, device controller simulator 230 may include a disk controller simulator and storage component simulator 232 may simulate physical disk components such as the disk surface, disk heads, disk motor, and the like.

FIG. 2 shows an Operating System (OS) 200 including a user space 202 and a kernel space 204. Embodiments of an OS include Microsoft Windows®, the Apple Macintosh® operating system, the Linux® operating system, the Unix® operating system, and the like. Instructions may execute in user space 202 or in kernel space 204. Instructions operating in kernel space 204 operate in a more privileged area of OS 200. Kernel space 204 may include system services such as process management, memory management, power management, Input/Output manager, device drivers, and the like. Instruction in user space 202 may include applications or other user processes. Often, instructions in user space 202 may interact with physical hardware using system calls to kernel space 204. Alternative embodiments of OS 200 may include an embedded OS.

A test application 206 may execute in user space 202. Test application 206 enables testing of software components that communicate with a simulated storage device. Test application 206 may allow scripting for automated testing and logging of test results for later analysis. Test application 206 may request functions of USB storage device simulator 218 (e.g., read/write data) using system calls to OS 200 in order to test device drivers as well as other system software.

Also, test application 206 may communicate with USB bus simulator 215 and USB storage device simulator 218 using one or more interfaces 224, such as a Component Object Model (COM) interface. Interfaces 224 allow the test application to perform “physical” actions on the USB storage device simulator 218. Such actions include ejecting a disk, connecting/disconnecting USB storage device simulator 218 from USB host controller simulator 216 (e.g., a Hot Plug event), and the like. Test application 206 monitors how software components, such as device driver, react to such events.

Test application 206 may also be used for fault injection into the USB storage device simulator 218. For example, test application 206 may use interface 224 to simulate a “bad” block on a simulated hard disk. Test application 206 may then run a test of the simulated hard disk to determine if the system software identifies the correct block as the bad block. For example, test application 206 may determine if the system software detects a failure of a disk block Cyclical Redundancy Check (CRC).

USB bus simulator 215 and USB storage device simulator 218 interact with an OS driver stack 208 as would a real piece of hardware. USB bus simulator 215 and USB storage device simulator 218 function as real hardware from the standpoint of OS 200. OS driver stack 208 is not aware that it is running with a simulated storage device and there is no code in the host controller simulator nor the device simulator that is dependent on specific behavior of OS driver stack 208. OS driver stack 208 reads/writes to registers, receives interrupts, and so on, as if OS driver stack 208 is communicating with a physical bus and physical storage device. The code of OS driver stack 208 is not modified in order to operate with simulated storage devices; the same code is used to operate with physical hardware. While embodiments herein describe interaction with OS driver stack 208, it will be understood that this is one example of how OS 200 may interact with devices. Embodiments herein include other OS designs for device interaction.

Embodiments herein provided high fidelity based software simulation of storage devices to facilitate common test activities and enable automation of such testing. Errors may be scripted via test application 206 such as protocol errors, long time-outs and retries, soft errors, and the like. Storage devices, such as hard disks, that are larger than those available today may be modeled. Storage device simulator 218 may be reconfigured under program control using test application 206 rather than manually. Such automated testing reduces costs associated with manual testing by human test engineers. Also, the entire stack 208 may be tested for its interaction with storage device simulator 218. Device driver developers may test a device driver (or other software) with a simulated storage device before the real hardware is available. In one embodiment, embodiments of the invention may be part of a Microsoft Windows Driver Kit (WDK).

In one embodiment, OS driver stack 208 includes a Microsoft Windows XP® USB driver stack. However, one skilled in the art will appreciate how embodiments herein may be adapted to other versions of Microsoft Windows® as well as other operating systems.

In FIG. 2, OS driver stack 208 includes a USB client device driver 209, stacked on a USB Hub Driver 210 (e.g., USBHUB.SYS), stacked on a host controller driver 212 (e.g., USBPORT.SYS), stacked on one or more miniport drivers 214. USB client device driver 209 may include a device driver written by a hardware vendor to accompany a particular hardware device. For example, USB client device driver 209 may include a device driver for a particular hard drive. USB client device driver 209 may also include a USB mass storage driver (e.g., USBSTOR.SYS).

A miniport driver 214 may include USBUHCI.SYS (Universal Host Controller Interface), USBOHCI.SYS (Open Host Controller Interface), USBEHCI.SYS (Enhanced Host Controller Interface), or USBWHCI.SYS (Wireless Host Controller Interface). Conventionally, a miniport driver has a companion hardware host controller. The miniport driver has knowledge of the host controller register definitions. For example, a USBEHCI.SYS miniport driver is matched to a hardware EHCI host controller. In embodiments herein, the hardware EHCI host controller is simulated by software without the need for modification of the miniport driver or knowledge of the simulation by the miniport driver.

In one embodiment, storage device simulator 218 is supported by a Device Simulation Framework (DSF). In short, the DSF includes user mode and kernel mode components, shown as user mode DSF 222 and kernel mode DSF 220, that facilitate the testing of system software using simulated buses and simulated devices. Embodiments of DSF are presented in commonly assigned U.S. patent application Ser. No. 10/435,481, filed May 8, 2003, titled “System and Method for Testing, Simulating, and Controlling Computer Software and Hardware”, which is incorporated herein by reference in its entirety.

FIG. 2 shows OS driver stack 208 coupled to kernel mode DSF 220. Kernel mode DSF 220 communicates with USB bus simulator 215 which in turn communicates with USB storage device simulator 218. Test application 206 communicates with user mode DSF 222 which in turn communicates with kernel mode DSF 220.

Test application 206 communicates with USB client device driver 209 via user mode DSF 222 and kernel mode DSF 220 in order for test application 206 to operate USB storage device simulator 218. For example, test application 206 may read or write data to USB storage device simulator 218.

User mode DSF 222 components include a USB host controller simulator object model (e.g., SoftEHCI.dII), a framework object model (e.g., DSFUSvcs.dII) and a framework client (e.g., DSFUSvcs.dII). Kernel mode DSF 220 includes a DSF kernel services component (e.g., DSFKSvcs.sys), hardware access and redirection modules (HRMs), as well as a root-enumerated driver (e.g., DSFRoot.sys).

In general, DSF kernel services implements the kernel mode logic of the DSF. For example, DSF kernel services creates a USB host controller simulator 216 and USB storage device simulator 218. Further, DSF kernel services stores data that represents the current set of simulated controllers and devices in the system.

In one embodiment, USB host controller simulator 216 is a DSF kernel mode simulator driver that loads as a lower device filter on the EHCI miniport driver (USBEHCI.SYS) on Microsoft Windows XP® and later operating systems. It intercepts hardware access by stack 208 for registers, configuration space, interrupts, Direct Memory Access (DMA), and the like. The EHCI miniport driver is not aware that it is running with a simulated host controller and there is no code in the host controller simulator that is dependent on specific behavior of the miniport driver. In an alternative embodiment, USB host controller simulator 216 is a DSF user mode simulator driver.

HRMs are dynamically loadable software components that are configured to intercept and control data communicated with the OS driver stack 208. Tasks of a root enumerated driver may include assisting in loading new device drivers into the system as well as registration of software objects created by the DSF. For example, an HRM may simulate the appearance of a hardware interrupt to stack 208 components, such as client device driver 209. In another example, an HRM may capture data written to the simulated storage device and forward the data to actual storage. This actual storage may be system memory. The speed of memory enables the storage device simulator to model actual access times of the device being simulated. In yet another example, an HRM may intercept and redirect port and register access calls by stack 208.

In user space 202, test application 206 may communicate with user mode DSF 222 via Component Object Model (COM) interfaces. User mode DSF 222 exposes COM objects in both user mode and kernel mode. User mode DSF 222 may include functions to create and destroy simulated buses, including bus controllers, and devices.

USB storage device simulator 218 may be created from a “raw” simulated USB device. This raw simulated USB device serves as a template that can be configured to behave as a particular device. A raw simulated USB device includes features that are common to USB devices regardless of device class. Storage devices for use with other bus architectures may be created from similar “raw” devices, such as a “raw” fibre channel device.

Various properties of a raw simulated device may be set to configure the raw device simulator to a particular type of hardware device. The raw simulated device may be configured by creating descriptor objects. The raw simulated device is constructed of multiple sub-objects to make it usable from script clients. These descriptor objects determine the behavior of the simulated device.

In a USB simulation, these USB descriptors include device, device qualifier, configuration, interface, endpoint, and string, as discussed in the USB 2.0 specification. A USB device descriptor provides general information about a USB device. Device qualifier describes information about a high-speed capable device that would change if the device were operating at other speeds. Configurations describe a specific device configuration. Interfaces expose functionality of the USB device. This functionality may be accessed through methods of simulator objects. In one embodiment, interfaces may be coded by the hardware manufacturer to simulate their particular hardware device. Strings may provide hardware identification as well as other alphanumeric information associated with a USB device.

Endpoints refer to the addressing of the simulated USB device by the simulated host controller. Endpoint 0 is common to all USB devices and provides access to a device's configuration information as well as for device status and control. A USB device may have additional endpoints to implement particular device functions.

Once the raw simulated device is configured to particular USB device, it is ready to be plugged into a simulated host controller. The simulated USB device may handle all aspects of connection to the host system on its own. The USB device simulator responds to standard device requests received on endpoint 0 using the descriptors configured earlier, as well as requests to other endpoints.

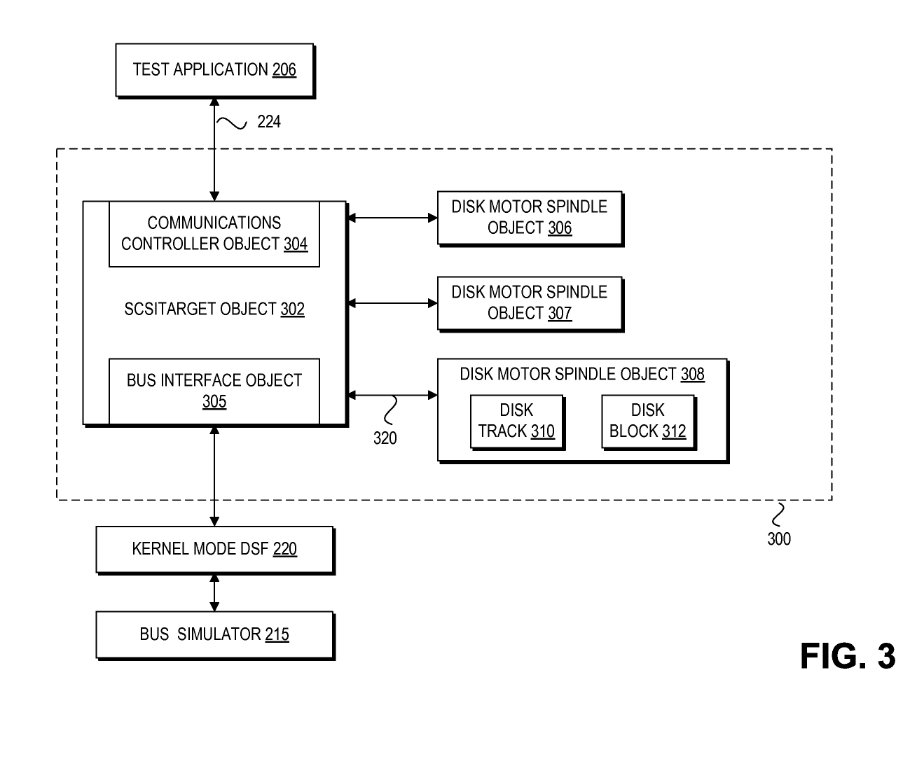

Turning to FIG. 3, an embodiment of a storage device simulator 300 to simulate a hard disk drive is shown. Storage device simulator 300 may simulate other storage devices such as tape drives, flash drives, and the like. Embodiments of storage device simulator 300 will be discussed in relation to various Small Computer System Interface (SCSI) specifications promulgated by the T10 Technical Committee on SCSI Storage Interfaces. However, embodiments of the invention are not limited to SCSI and may be implemented using other storage interface architectures.

Storage device simulator 300 includes a disk controller simulator, shown as SCSITarget Object 302, which interacts with three storage component simulators, DiskMotorSpindle objects 306, 307, and 308. SCSITarget object 302 is a member of a SCSITarget class to simulate a disk controller. DiskMotorSpindle objects 306-308 are members of the DiskMotorSpindle class to simulate the disk, heads, motor, and spindle of the hard disk itself. Three DiskMotorSpindle objects are shown as an example, however, alternative embodiments may include more or less DiskMotorSpindle objects as desired.

The DiskMotorSpindle class models the physical workings of a disk drive. In one embodiment, multiple DiskMotorSpindle objects may be used to model a multilayer disk/head arrangement. In other embodiments, the DiskMotorSpindle class may be sub-classed in order to present a serpentine disk, such as a CD, DVD, and the like. Communications to a DiskMotorSpindle object may be made through a method invocation, such as shown at 320, by SCSITarget object 302. DiskMotorSpindle may include subclasses such as a disk track object 310 to simulate disk tracks and a disk block object 312 to simulate disk blocks.

A DiskMotorSpindle object may simulate the storage capacity of a storage device via a file mapping. On 32-bit machines, the simulated disk size may be limited to 4 gigabytes (the virtual memory limit). In use on 64-bit machines, the simulated disk may reach sizes of 18 terabytes due to the greater virtual memory limit of 64-bit machines.

DiskMotorSpindle may model the blocks of a disk surface. For example, the number of blocks per track may vary from the inside track to the outside track to model hard disk drive designs which do this. Also, the simulated blocks may be stored with Cyclical Redundancy Check (CRC) data.

Also, the simulated blocks may have block numbers as may an actual disk drive. These block numbers allow the transparent spanning of data across physical disk drives for simulating a single disk drive since multiple paging files can be used across multiple physical disk drives. For example, two 500 Gigabyte physical drives can use spanning to simulate a single 1000 Gigabyte drive.

A DiskMotorSpindle object may be written to and read from as an actual storage device. In one embodiment, a single file system of sufficient size is used to hold the data saved to the simulated disk. In one embodiment, data may be saved in a sparse format. A sparse format includes saving the data in a series of disk blocks even though the simulated disk has the equivalent number of blocks as the physical disk being simulated. In this way, the space required for saving the data is only for the blocks that have actually been written to.

In addition to simulating storage capacity and read/write functionality, a DiskMotorSpindle object may simulate disk timing parameters. Storage device simulator 300 may offer real-time performance. In one embodiment, track to track seek times may be used to model short distance head seeks, while end to end seek times may be used to model longer distance seek times. Track to track seek times and end to end seek times are often specified by a disk drive manufacturer. A track to track seek time is the time to move the head from one track to an adjacent track on the disk surface. For simulator modeling, the track to track seek time provides the least opportunity for acceleration and so represents the minimum practical head speed. An end to end seek time includes the time that the disk unit takes to seek the head from the innermost to outermost tracks of a disk surface. For simulator modeling, end to end seek time may represent the maximum achievable head velocity.

In one embodiment, a seek time may be modeled as follows. First, the proportion of the distance seeked in tracks to the end to end distance in tracks is computed. Next, this result is multiplied by the end to end seek time to find the seek time. This allows the modeling of acceleration characteristics of the head unit.

The SCSITarget class acts as a disk controller for the storage device. In one embodiment, the SCSITarget class may simulate specific vendor equipment. The simulation of vendor equipment may include duplicating the correct inquiry information and any well known protocol errors in the specific storage device. In one embodiment, storage device simulator 300 may respond with inquiry information as defined by the SCSI specifications.

In one embodiment, SCSITarget class may include a member class called the CommunicationsController class used to create a CommunicationsController object 304. The CommunicationsController class allows the communication of control information from test application 206. This allows for the modeling of external events such as power on/off, media injection and insertion, and fault injection. CommunicationsController object 304 opens an asynchronous communications channel with the SCSITarget, and speaks a protocol which is defined in the SCSITarget class.

SCSITarget may also include a member class called BusInterface used to create a BusInterface object 305. BusInterface object 305 may communicate with kernel mode DSF 220 components, such as DSF kernel services or a protocol forwarder, which in turn communicate with bus simulator 215.

The SCSITarget class may spawn three threads, one for Communications Controller object 304, one for BusInterface object 305, and one for the DiskMotorSpindle objects 306-308. The SCSITarget class may also duplicate the caching operations by the storage device, such as track caching.

The SCSITarget class may support various SCSI specifications. For example, the SCSITarget class may support the SPC (SCSI Primary Commands) command set, the SBC (SCSI Block Commands) command set, and the MMC (Multi-Media Command) command set. In one embodiment, SCSITarget may support the SCSI specification for Reduced Block Commands (RBC). Simulation of RBC devices, such as Secure Disk (SD) media, may be done by DiskMotorSpindle and a subclass of the SCSITarget class to act as a controller for the RBC device. In this embodiment, SCSITarget may throw an unsupported exception in the case of the commands which are not within the RBC command set.

It will be noted that storage device simulator 300 includes discreet, re-usable components, such as SCSITarget object 302 and DiskMotorSpindle objects 306-308. This component architecture enables developers to mix and match components as desired to create various device simulations. Developers may add or remove components as needed to model different pieces of hardware. Such component architecture also allows a developer to focus on modeling a particular new feature of a storage device while re-using previously built components for other features of the storage device. For example, a developer may re-use SCSITarget object 302 but create new DiskMotorSpindle objects to simulate different physical disks. In another example, a new DiskMotorSpindle object simulates a disk in the design stage so the developer may test a device driver to work with this new DiskMotorSpindle object and SCSITarget 302 before the disk hardware is actually available.

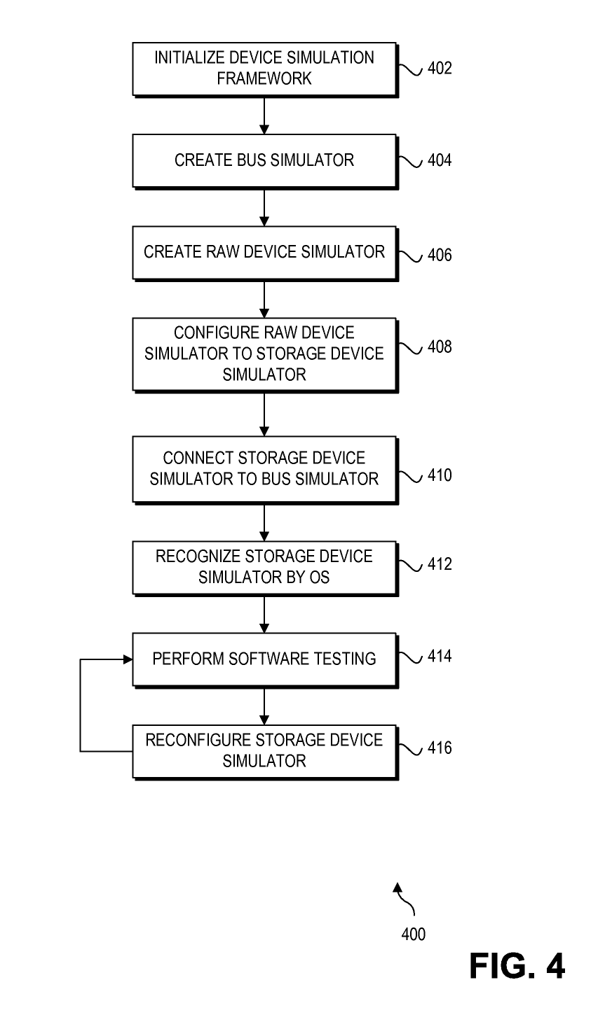

Turning to FIG. 4, a flowchart 400 shows an embodiment of simulating a storage device. Starting in block 402, a Device Simulation Framework is initialized on a computing device, such as computing device 100. Proceeding to block 404, a bus simulator is created. In one embodiment, creating the bus simulator may include creating a host controller simulator.

Continuing to blocks 406 and 408, a storage device simulator is created. In block 406, a raw device simulator is created. Continuing to block 408, the raw device simulator is configured to simulate a particular storage device. In an embodiment simulating a USB storage device, device descriptors are created from a raw USB device simulator to configure the raw USB device simulator to a particular USB storage device. Alternative embodiments may configure a raw device simulator for use with other buses, such as fibre channel, SAS, and the like. In embodiments as described above, the bus simulator and the storage device simulator may be created using DSF services.

Continuing to block 410, the storage device simulator is connected to the bus simulator. In one embodiment, test application 206 issues a hot plug command to USB host controller simulator 216 to “plug-in” USB storage device simulator 218.

After the storage device simulator is connected to the bus simulator, the storage device simulator is recognized by the OS, as shown in block 412. In an embodiment implemented in Microsoft Windows®, the simulated storage device appears in the Device Manager and is perceived by the OS as an actual hardware device. The OS may interact with the simulated storage device as if it is an actual piece of hardware.

Proceeding to a block 414, software testing may be performed. Such testing may be automated using scripting with test application 206. The automated testing may perform various functionality of the simulated storage device such as connecting/disconnecting from the bus, reading and writing data, and the like. Thus, various device configurations and test scenarios may be tested automatically without human intervention. Also, a fault may be injected into the storage device simulator using test application 206, and then a device driver tested for its reaction to such a fault.

A simulated storage device as described herein also enables a tester to put a break or a data logging point into the simulated storage device code for analyzing device driver behavior. For example, the tester may use a code break to examine exactly what bytes were received at the storage device simulator in response to a command from the device driver. Such testing is extremely valuable since the storage device simulator interacts with the OS as would an actual piece of hardware.

In flowchart 400, the logic proceeds to block 416 to reconfigure the storage device simulator. In one embodiment, scripting via test application 206 may be used to reconfigure the storage device simulator. A hardware vendor may test various storage devices in a single automated session. The discreet components of embodiments described herein facilitate this reconfiguration. In one embodiment, simulator objects may be created and connected/disconnected under script control to generate various simulated devices as desired. For example, DiskMotorSpindle object 306 may be disconnected from SCSITarget object 302 and replaced with a new DiskMotorSpindle object that simulates a different disk design. This may be done under script control without human intervention. After block 416, the logic may return to block 414 to perform software testing with the reconfigured storage device.

Various operations of embodiments of the present invention are described herein. In one embodiment, one or more of the operations described may constitute computer readable instructions stored on computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize. These modifications may be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
creating a storage device simulator on a computing device; and
connecting the storage device simulator to an operating system of the computing device, wherein the storage device simulator interacts with the operating system without modification of the operating system.

2. The method of claim 1 wherein creating the storage device simulator includes:
creating a raw device simulator; and
configuring the raw device simulator to create the storage device simulator.

3. The method of claim 1, further comprising performing software testing of a device driver associated with a hardware device simulated by the storage device simulator.

4. The method of claim 3 wherein performing software testing includes:
injecting a fault into the storage device simulator; and
observing a reaction of the device driver to the fault.

5. The method of claim 1 wherein data saved to the storage device simulator is spanned across multiple physical storage devices.

6. The method of claim 1, further comprising saving data to the storage device simulator, wherein the data is saved in a sparse format.

7. The method of claim 1 wherein the storage device simulator includes a device controller simulator and a storage component simulator.

8. The method of claim 7 wherein the storage device simulator simulates the storage capacity and the timing parameters of a hard disk drive.

9. The method of claim 7, further comprising disconnecting the storage component simulator from the device controller simulator and connecting a second storage component simulator to the device controller simulator to simulate a second storage device.

10. The method of claim 1, further comprising initializing a Device Simulation Framework (DSF) on the computing device to support the storage device simulator.

11. One or more computer readable media including computer readable instructions that, when executed, perform the method of claim 1.

12. One or more computer readable media including computer readable instructions that, when executed, perform operations comprising:
creating a host controller simulator object;
creating a storage device simulator object; and
connecting the storage device simulator object to the host controller simulator object, wherein the storage device simulator object interacts with an operating system such that the operating system is unaware that the storage device simulator object is a simulation.

13. The one or more computer readable media of claim 12 wherein creating the storage device simulator object includes:
creating a raw device simulator object; and
creating device descriptor objects from the raw device simulator object, wherein the device descriptor objects represent device descriptors that determine behavior of the storage device simulator object.

14. The one or more computer readable media of claim 12 wherein creating the storage device simulator object includes:
creating a disk controller simulator object; and
creating a physical disk simulator object to simulate physical workings of a disk drive.

15. The one or more computer readable media of claim 14 wherein the physical disk simulator object includes:
a disk-motor-spindle object to simulate a disk, a motor, and a spindle of a hard disk drive;
a disk track object to simulate tracks of the disk; and
a disk block object to simulate blocks of the disk.

16. The one or more computer readable media of claim 12 wherein the computer readable instructions, when executed, further perform operations comprising:
receiving a fault injection from a test application; and
simulating a fault in the storage device simulator in response to the fault injection.

17. One or more computer readable media including computer-executable storage device simulator module to simulate a storage device, comprising:
a storage device controller simulator module; and
a storage component simulator module logically connectable to the storage device controller simulator module, wherein the storage device simulator module to interact with an operating system such that the operating system is unaware that the storage device simulator module is a simulation.

18. The one or more computer readable media of claim 17 wherein the storage device simulator module to provide substantially similar storage capacity as the storage device.

19. The one or more computer readable media of claim 17 wherein the storage device simulator module to provide substantially similar read/write functionality as the storage device.

20. The one or more computer readable media of claim 17 wherein the storage device simulator module to provide substantially similar disk timing parameters as the storage device, wherein the storage device includes a hard disk drive.
